(19) United States
(12) Patent Application Publication
(10) Pub. No.: US 2015/0331346 A1
(43) Pub. Date: Nov. 19, 2015

(54) ELECTROPHOTOGRAPHIC MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Kazuhiro Yamauchi, Suntou-gun (JP); Satoru Nishioka, Suntou-gun (JP); Masaki Yamada, Mishima-shi (JP); Sosuke Yamaguchi, Susono-shi (JP); Hideya Arimura, Suntou-gun (JP)

(21) Appl. No.: 14/709,013

(22) Filed: May 11, 2015

(30) Foreign Application Priority Data
May 16, 2014 (JP) 2014-102898

(51) Int. Cl. B05C 1/08; B32B 9/04; B32B 27/40; G03G 15/02; G03G 15/08

(52) U.S. Cl. CPC G03G 15/00; C09D 183/04; C09D 175/04

(57) ABSTRACT

Provided is an electrophotographic electroconductive member in which an excessive decrease in resistance of an electroconductive roller in a high-temperature/humidity environment is suppressed and an electric resistance value in a low-temperature/humidity environment is reduced, and thus the electric resistance value is optimized without depending on use conditions and a usage environment. Also provided are a process cartridge and an electrophotographic apparatus that contribute to the stable formation of an electrophotographic image of high quality over a long period of time. The electrophotographic electroconductive member includes an electroconductive mandrel and an electroconductive resin layer formed on an outer periphery of the electroconductive mandrel. The electroconductive resin layer contains a cation and at least one kind of a bis(oxalato)borate anion or a tris(oxalato)phosphate anion.

### BACKGROUND OF THE INVENTION

1. Field of the Invention

The present invention relates to an electrophotographic member, a process cartridge, and an electrophotographic apparatus.

2. Description of the Related Art

An electrophotographic member is used for various applications such as a developer carrier (e.g., a developing roller), a transferring roller, a charging unit (e.g., a charging roller), a cleaning blade, and a developer layer thickness regulating member (e.g., a developing blade). It is preferred that such electrophotographic member have an electroconductive property with an electric resistance value of about from 10³ Ω·cm to 10¹⁰ Ω·cm. In Japanese Patent Application Laid-Open No. 2012-159807, there is a disclosure of the invention of an electroconductive roller to be used mainly in a developing device. Specifically, there is a disclosure of an electroconductive roller including an elastic layer formed on an outer peripheral surface of a mandrel and a urethane coat layer formed on an outer peripheral surface of the elastic layer, in which the urethane coat layer contains a urethane resin, at least one kind of a pyridinium-based ionic liquid or an amine-based ionic liquid in an amount of from 1 part by mass to 25 parts by mass with respect to 100 parts by mass of the urethane resin, and a carboxylic acid-based metal compound in an amount of from 1 part by mass to 25 parts by mass with respect to 100 parts by mass of the urethane resin. There is also a disclosure that the electroconductive roller can satisfy both a developer charge-removing function in a low-humidity environment and a developer charging function in a high-humidity environment, which have been hitherto considered to have a trade-off relationship, with a favorable balance.

The present invention is directed to providing an electrophotographic member having electric resistance that is less liable to be changed even by a fluctuation of the surrounding humidity environment.

The present invention is also directed to providing a process cartridge and an electrophotographic apparatus that are capable of stably outputting an electrophotographic image of high quality through use of the electrophotographic member according to the present invention.

### SUMMARY OF THE INVENTION

According to one embodiment of the present invention, there is provided an electrophotographic member, including: an electroconductive substrate; and an electroconductive resin layer formed on the electroconductive substrate,

the electroconductive resin layer including a cation and at least one kind of a bis(oxalato)borate anion or a tris(oxalato)phosphate anion.

According to another embodiment of the present invention, there is provided a process cartridge, which is removably mounted onto a main body of an electrophotographic apparatus, the process cartridge including the above-mentioned electrophotographic member. According to still another embodiment of the present invention, there is provided an electrophotographic apparatus including the above-mentioned electrophotographic member.

Further features of the present invention will become apparent from the following description of exemplary embodiments with reference to the attached drawings.

### BRIEF DESCRIPTION OF THE DRAWINGS

FIG. 1A, FIG. 1B, and FIG. 1C are schematic sectional views for illustrating an example of an electrophotographic member according to the present invention.

FIG. 2 is an explanatory view of a process cartridge according to the present invention.

FIG. 3 is an explanatory view of an electrophotographic apparatus according to the present invention.

FIGS. 4A and 4B are schematic configuration views of a device for evaluating a charging roller incorporated into the electrophotographic apparatus.

### DESCRIPTION OF THE EMBODIMENTS

Preferred Embodiments of the Present Invention will now be described in detail in accordance with the accompanying drawings.

The inventors of the present invention investigated the use of the electroconductive roller of Japanese Patent Application Laid-Open No. 2012-159807 as a developing roller and found the following. The effect of suppressing excessive charging of a developer may decrease in a low-temperature/humidity (LL) environment such as a temperature of 15° C. and a relative humidity of 10% RH. As a result, in the case where the electroconductive roller is used as a developing roller for forming an electrophotographic image over a long period of time, the developer is excessively charged, and a toner regulation failure occurs in some cases. The toner regulation failure may cause, for example, an image defect called a ghost or image defects such as dot-like unevenness in a non-printed portion and a toner lump formed on an image.

On the other hand, in the case where the electroconductive roller is used as a developing roller for forming an electrophotographic image over a long period of time in a high-temperature/humidity (HH) environment such as a temperature of 32.5° C. and a relative humidity of 85% RH, the charged amount of a developer may become insufficient. Therefore, when a white solid image formed of a non-printed portion to which the developer is not allowed to adhere is output, the white solid image may be colored with the developer.

Further, in the case where the electroconductive roller is used as a charging unit, the resistance of the charging unit increases in the low-temperature/humidity (L/L) environment, and the ability of the charging unit to charge a body to be charged may be degraded. Further, in the high-temperature/humidity (H/H) environment, pinhole leak may occur at a time of charging of the body to be charged. The pinhole peak refers to the following phenomenon: in the case where a photosensitive layer of a photosensitive member has a defect part, an excessive current from the charging roller is concentrated on the defect part, and thereby a portion that cannot be charged is formed around the defect part of the photosensitive layer.

Further, also in the case where the electroconductive roller is applied to a transferring roller, a change in electric resistance caused by a fluctuation in the surrounding humidity environment becomes an obstacle to the stable formation of an electrophotographic image of higher quality.

The inventors of the present invention found that, in order to eliminate the influence of humidity in a usage environment on the electric resistance value of an electrophotographic member to the extent possible, it was preferred to first suppress an excessive decrease in resistance of the electrophotographic member in the H/H environment by reducing a water amount in a binder resin. Based on this finding, the inventors of the present invention considered that it was necessary to investigate how to decrease the electric resistance value of the electroconductive roller in the L/L environment.

An electroconductivity σ exhibiting electrical characteristics can be represented by the following mathematical expression 1.

σ=qnμ Mathematical expression 1

In the mathematical expression 1, σ represents an electroconductivity, q represents carrier charge, n represents a carrier density, and μ represents a carrier mobility. A carrier in the case of ion conduction refers to an ion conducting agent ionized by the dissociation of an anion and a cation. In general, the ion conducting agent is formed of an ion-exchange group such as a quaternary ammonium group and an ion (for example, a chlorine ion) having a polarity opposite to that of the ion-exchange group, and both the ion-exchange group and the ion having an opposite polarity move in the binder resin to exhibit an ion conductive property.

Water in the binder resin accelerates the dissociation of ions of the ion conducting agent and thus increases the carrier density n in the mathematical expression 1. Further, the presence of water having low viscosity in the binder resin facilitates the movement of the ions and hence increases the carrier mobility p in the mathematical expression 1. That is, the most significant factor for a great change in electric resistance value of the charging roller caused by the usage environment is considered to be a change in water amount in the binder resin. Thus, in the H/H environment, in which the absorption of water easily occurs, the binder resin containing the ion conducting agent decreases in resistance excessively, and in the L/L environment, in which the absorption of water does not easily occur, the binder resin containing the ion conducting agent increases in resistance. Such a phenomenon cannot be avoided.

In view of the above-mentioned circumstances, in order to optimize the electric resistance value without depending on the usage environment, the inventors of the present invention conducted an investigation on reducing the electric resistance value without depending on the water amount in the binder resin. As a result, the inventors of the present invention found that, in the case of using an ion conducting agent containing, as an anion, a bis(oxalato)borate anion or a tris(oxalato)phosphate anion, a change in resistance by the usage environment was suppressed to the extent possible, and thus the electric resistance value was able to be optimized. In relation to this, the inventors of the present invention consider as follows. The bis(oxalato)borate anion and the tris(oxalato)phosphate anion are less liable to be influenced by water due to the high hydrophobicity thereof and accelerate the ion dissociation from cations even in the case where the binder resin contains water in a small amount. Further, among anions having hydrophobicity, the bis(oxalato)borate anion and the tris(oxalato)phosphate anion have a relatively small molecular weight and hence can achieve a higher carrier mobility. As a result, the electric resistance value of the electrophotographic member can be optimized without depending on the usage environment.

Now, the present invention is described in detail. The electrophotographic member according to the present invention includes a developer carrier (e.g., a developing roller), a transferring roller, a charging unit (e.g., a charging roller), a cleaning blade, a developer layer thickness regulating member (e.g., a developing blade), a transferring member, a charge-removing member, and a conveyance member such as a sheet feeding roller. The electrophotographic member according to the present invention is hereinafter described in detail with reference to the case of using the electrophotographic member as a charging roller or a developing roller, but the form and applications of the electrophotographic member according to the present invention are not limited thereto.

It is preferred that the electric resistance value of the electrophotographic member according to the present invention be 1×10³ Ω·cm or more and 1×10⁹ Ω·cm or less. Further, it is preferred that the electric resistance value of the electroconductive resin layer containing the ion conducting agent according to the present invention be 1×10⁵ Ω·cm or more and 1×10⁸ Ω·cm or less.

<Electroconductive Substrate>

As an electroconductive substrate, any substrate can be appropriately selected and used from those known in the field of electrophotographic members, such as a cylindrical or columnar substrate and a flat plate substrate, depending on the intended structure and function of an electrophotographic member. In the case of forming a roller-shaped electroconductive substrate, for example, a columnar material obtained by plating a surface of a carbon steel alloy with nickel to a thickness of about 5 μm can be used as the electroconductive substrate.

<Electroconductive Resin Layer>

Now, an anion and a cation forming an electroconductive resin layer are described.

(1-1) Anion

In the present invention, the electroconductive resin layer contains an oxalate complex anion.

As the oxalate complex anion, at least one of a bis(oxalato)borate anion or a tris(oxalato)phosphate anion is used. Those oxalate complex anions have an effect of suppressing an excessive decrease in resistance in the H/H environment due to their feature of low hygroscopicity, compared to halogen-based anions such as chlorine, bromine, and perchloric acid anions.

Further, the oxalate complex anion does not contain a fluorine atom in a molecular structure. Fluorine has plus charge (positive charge) imparting performance by triboelectric charging while having the effect of suppressing an excessive decrease in resistance in the H/H environment due to high hydrophobicity.

In the case where a minus voltage is applied to a charging roller containing a component having such a positive charge imparting property, a positively charged toner is generated, and the positively charged toner becomes stable electrically when adhering to the charging roller rather than a surface of a photosensitive member. Therefore, there is a risk in that the charging roller may be contaminated with the toner. The similar positive charging occurs also in an external additive, and there is a risk in that the charging roller may be contaminated with the external additive.

It should be noted that a developing roller is also required to have a property of imparting minus charge (negative charge) to a toner and thus there is a risk in that image fog may be caused when the chargeability of the toner decreases. As described above, the electrophotographic member is required to have a function of negatively charging the toner and the external additive. As examples of a boron-based anion and a phosphorus-based anion, there can be given a boron tetrafluoride anion and a phosphorus hexafluoride anion. However, both the anions contain a fluorine atom in a molecular structure and hence have a poor negative charge imparting property for the above-mentioned reason. On the other hand, the oxalate complex anion used as the anion in the present invention is a complex anion containing an oxalate group as a ligand of boron or phosphorus and does not contain a fluorine atom. Thus, it is not necessary to consider the occurrence of the above-mentioned problem caused by the positive charging of the toner and the external additive. Further, the oxalate complex anion has a relatively small molecular size among the boron-based anion and the phosphorus-based anion. In the case where the anion has a small molecular size, the anion has an advantage in terms of the movement in the binder resin as an ion carrier. As a result, a decrease in resistance can be realized in the L/L environment. This effect is also exhibited in a binder resin in which the movement of an ion carrier is suppressed due to high cross-linking density.

(1-2) Cation

A cation is not particularly limited as long as it can act as a cation for obtaining an intended effect by using an oxalate complex anion.

Examples of the cation include monovalent cations including: an alkali metal ion such as a lithium ion, a sodium ion, and a potassium ion; an imidazolium ion; a pyrrolidinium ion; and a quaternary ammonium cation.

Of the above-mentioned ion species, an imidazolium ion, a pyrrolidinium ion, or a quaternary ammonium cation is preferably used as the cation in the electroconductive resin layer including the oxalate complex anion in order to achieve a decrease in resistance in the L/L environment. In particular, the quaternary ammonium cation is suitable because of its good ionic dissociation property from an anion.

Further, a combination of the oxalate complex anion and the quaternary ammonium cation has characteristics of an ionic liquid. The ionic liquid is present as a liquid also in a state of containing water in a small amount and can move in the binder resin. As a result, a decrease in electric resistance in the low-humidity environment can be improved. In this respect, the above-mentioned combination is preferred. In this case, the ionic liquid refers to a molten salt having a melting point of 100° C. or less. It is preferred that the molecular weight of the quaternary ammonium cation be lower because an ionic liquid is easily formed. In particular, the quaternary ammonium cation having a molecular weight of 200 or less is preferred because a high electroconductive property can be maintained in the L/L environment.

It can be confirmed whether or not the electroconductive resin layer contains the above-mentioned anion and cation (hereinafter sometimes referred to simply as “ions”) by subjecting the electroconductive resin layer to an extraction measurement method. For conducting the extraction measurement, first, the electroconductive resin layer is cut out from an electroconductive roller. The electroconductive resin layer thus cut out from the electroconductive roller is immersed in a diluted aqueous solution of hydrochloric acid or sodium hydroxide, followed by stirring, to extract ions in the electroconductive resin layer into the aqueous solution. The aqueous solution after the extraction is dried, and the extract is collected and then subjected to mass analysis using a time-of-flight mass spectrometer (TOF-MS). Thus, the ions can be identified. The ions can be identified more easily by further subjecting the extract to element analysis by inductively-coupled plasma (ICP) emission spectrometry and combining the results obtained from the element analysis with those from the mass analysis.

In addition, the cation according to the present invention may be a cationic group covalently bound to a binder resin to be described later.

In this case, examples of the cationic group to be immobilized in the binder resin include a quaternary ammonium group, a sulfonium group, a phosphonium group, and a nitrogen-containing heterocyclic group. Examples of the nitrogen-containing heterocyclic group include a piperidinium group, a pyrrolidinium group, a morpholinium group, an oxazolium group, a pyridinium group, a pyrimidinium group, a pyrazinium group, a pyridazinium group, an imidazolium group, a pyrazolium group, a triazolium group, hydrides thereof, and derivatives thereof.

It should be noted that the monovalent cationic group may be contained in the electroconductive resin layer in a state of being bound to a resin or a rubber contained in the electroconductive resin layer, for example, a resin or a rubber serving as a binder. A method of forming the cation according to the present invention by chemically binding those cationic groups to the binder resin in the above-mentioned manner is described later.

(2) Resin for Forming Electroonductive Resin Layer

There is no particular limitation on a resin for forming the electroconductive resin layer, for example, a binder resin, and the binder resin can be selected and used from those used for forming electroconductive resin layers of electrophotographic members. Examples of the binder resin include resins such as an epoxy resin, a urethane resin, a urea resin, an ester resin, an amide resin, an imide resin, an amide-imide resin, a phenol resin, a vinyl resin, a silicone resin, and a fluorine resin; an epichlorohydrin homopolymer; an epichlorohydrin-ethylene oxide copolymer; an epichlorohydrin-ethylene oxide-allyl glycidyl ether terpolymer; an acrylonitrile-butadiene copolymer; a hydrogenated product of an acrylonitrile-butadiene copolymer; and rubbers such as a silicone rubber, an acrylic rubber, and a urethane rubber. One kind of those binder resins may be used alone, or two or more kinds thereof may be used in combination.

<Moisture Content of Resin Contained in Electroonductive Resin Layer>

An excessive decrease in resistance in the H/H environment can be prevented by reducing the water amount of the resin contained in the electroconductive resin layer, for example, the binder resin, and hence it is preferred that the binder resin be a hydrophobic resin. As a guideline of the hydrophobicity of the binder resin, it is preferred that the moisture content of the electroconductive resin layer containing the binder resin be 15 mass % or less in an environment having a temperature of 30° C. and a relative humidity of 80% RH. As a result of the investigations by the inventors of the present invention, it has been confirmed that, under the condition that the moisture content of the electroconductive resin layer is 15 mass % or less, the effect of suppressing an excessive decrease in resistance in the H/H environment and the effect of suppressing an increase in resistance in the L/L environment by the oxalate complex anion tend to become further remarkable.

The moisture content of 15 mass % or less can be easily achieved, for example, by introducing a siloxane structure into the binder resin. In the case where the electroconductive resin layer having the siloxane structure introduced thereto is used for an outermost layer of the charging roller, the surface free energy of the charging roller becomes low. Therefore, it is preferred that the electroconductive resin layer be used also from the viewpoint that the adhesion of toner and an external additive of the toner can be reduced.

As the siloxane structure to be used in the binder resin, for example, a unit structure represented by the following chemical formula (1) is preferred.

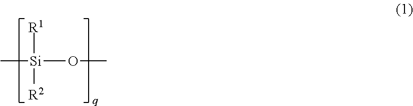

(In the chemical formula (1), R¹ and R² each independently represent a methyl group or an unsubstituted phenyl group, and q represents an integer of 1 or more.)

Roughness-providing particles, a filler, a softener, and the like may be added to the electroconductive resin layer in such a range that the effects of the present invention are not impaired. It is preferred that the content of the binder resin be 20 mass % or more with respect to the electroconductive resin layer. More specifically, it is more preferred that the content of the binder resin be 40 mass % or more with respect to the electroconductive resin layer. The reason for this is as follows. When the binder resin forms a continuous phase in the electroconductive resin layer, the electroconductive resin layer exhibits an ion conductive property, and the continuous phase can be formed easily by setting the content of the binder resin to 40 mass % or more. The upper limit of the content ratio of the binder resin in the electroconductive resin layer is defined by the content ratio of the components other than the binder resin.

The moisture content in the electroconductive resin layer can be measured by the following method. The electrophotographic member is left to stand in an environment having a temperature of 30° C. and a relative humidity of 80% RH for 3 days or more, and the electroconductive resin layer is cut out from the resultant electrophotographic member to provide a test piece. The test piece thus cut out from the electroconductive resin layer is filled into a measurement cell in an environment having a temperature of 30° C. and a relative humidity of 80% RH and sealed. In this state, the water amount of the test piece sealed in the measurement cell is measured through use of a Karl Fischer's moisture meter.

<Flexibility of Resin Contained in Electroonductive Resin Layer>

In the case of using a binder resin having high molecular mobility as the resin contained in the electroconductive resin layer, for example, the binder resin, ions can move easily, and thus a decrease in resistance in the L/L environment can be achieved. However, in the case where the molecular mobility of the binder resin is high, the binder resin becomes flexible to increase in tackiness. As a result, the performance of preventing fouling caused by the adhesion of the toner, the external additive, and the like is degraded. Thus, when the number of output electrophotographic images increases with long-term use, streak-like image density unevenness may occur.

In the present invention, a decrease in resistance of the electroconductive resin layer can be achieved even in the case where the molecular mobility of the binder resin is relatively low, by incorporating the oxalate complex anion into the ion conducting agent. Therefore, it is not necessarily required to use a binder resin having high molecular mobility for a decrease in resistance of the electroconductive resin layer in the L/L environment. Thus, a decrease in resistance of the electroconductive resin layer in the L/L environment can be achieved even with a binder resin having low molecular mobility, and a satisfactory image can also be formed after long-term use.

From the above-mentioned viewpoint, it is preferred to use a binder resin having low molecular mobility in consideration of the effect of preventing fouling caused by the adhesion of the toner, the external additive, and the like. As the binder resin, it is preferred to use a binder resin capable of forming such an electroconductive resin layer that a spin-spin relaxation time T2 to be determined by pulse NMR measurement is 1,000 microseconds (μsec) or less in an environment having a temperature of 15° C. and a relative humidity of 10% RH. It should be noted that the molecular mobility of the binder resin can be generally evaluated based on the spin-spin relaxation time T2 with a hydrogen nucleus as a measurement nucleus, which can be determined by pulse NMR measurement, and the longer spin-spin relaxation time T2 means higher molecular mobility.

As a monomer unit having low molecular mobility, for example, there are given a siloxane structure, an alkylene oxide structure, and a straight-chain alkyl structure. In particular, it is preferred to use a binder resin having a siloxane structure together with an ion conducting agent containing an oxalate complex anion. The compatibility between the binder resin having a siloxane structure and the ion conducting agent containing an oxalate complex anion is satisfactory, as compared to that between the binder resin and a hydrophilic ion conducting agent or a halogen-based hydrophobic ion conducting agent. Therefore, the inventors of the present invention consider that an increase in resistance in the L/L environment can be further suppressed.

An increase in resistance in the L/L environment can be easily suppressed without depending on the process speed of the electrophotographic apparatus and the roller configuration, by adding the ion conducting agent containing an oxalate complex anion to the electroconductive resin layer and setting the spin-spin relaxation time T2 of the electroconductive resin layer to the above-mentioned condition. It should be noted that, in order to achieve the above-mentioned condition, for example, it is appropriate that a binder resin having a high cross-linking density be used as the binder resin in the electroconductive resin layer.

In order to control the cross-linking density of the binder resin, for example, the following method can be used.

It is appropriate to control the cross-linking density of the binder resin by using, as raw materials, a polyfunctional compound having two or more reactive functional groups and a compound that is polymerizable by itself and selecting the blending ratio of the polyfunctional compound and the molecular weights of the raw material compounds, in particular, the molecular weight of the polyfunctional compound. Further, a binder resin having a desired cross-linking degree can also be obtained by causing a cross-linking agent to act on a resin that can be used as a binder and appropriately setting the condition of a cross-linking reaction.

Examples of the binder resin whose cross-linking density can be adjusted include an epoxy resin, a urethane resin, a urea resin, an ester resin, an amide resin, an imide resin, an amide-imide resin, a phenol resin, a vinyl resin, a silicone resin, and a fluorine resin. Of those, an epoxy resin, a urethane resin, a urea resin, an amide resin, or an ester resin is preferred in the present invention, because the cross-linking density thereof can be precisely controlled by selecting a monomer compound as a raw material. The binder resin is more preferably an epoxy resin, a urethane resin, or a urea resin.

Examples of the raw material for forming the binder resin include, but not limited to, a polyglycidyl compound, a polyamine compound, a polycarboxy compound, a polyisocyanate compound, a polyhydric alcohol compound, a phenol compound, and a vinyl compound.

It should be noted that, as the raw material for forming the binder resin, a plurality of kinds of raw material compounds including the above-mentioned binder resin may be used together. It is not necessarily required to increase the number of linked units of all the raw materials as long as the spin-spin relaxation time T2 of the electroconductive resin layer to be obtained satisfies 1,000 μsec or less.

The number of linked units in the binder resin can be estimated, for example, by ionizing a sample through use of matrix-assisted laser desorption/ionization (MALDI) or surface-assisted laser desorption/ionization (SALDI) and subjecting the ionized sample to mass analysis using a time-of-flight mass spectrometer (TOF-MS).

It is appropriate that the spin-spin relaxation time T2 of the electroconductive resin layer be measured by the following method. The electrophotographic member is left to stand in an environment having a temperature of 15° C. and a relative humidity of 10% RH for 3 days or more, and the electroconductive resin layer is cut out from the resultant electrophotographic member to provide a test piece. The test piece thus cut out from the electroconductive resin layer is filled into a measurement cell in an environment having a temperature of 15° C. and a relative humidity of 10% RH and sealed. In this state, the spin-spin relaxation time T2 of the test piece sealed in the measurement cell is measured through use of a pulse NMR measurement device. It should be noted that, in the present invention, the spin-spin relaxation time T2 with a hydrogen nucleus as a measurement nucleus is measured by a solid echo method. The measurement conditions are a measurement frequency of 20 MHz, a pulse width of 2.0 μsec, a pulse interval of 12 μsec, and a number of scans of 128. A T2 relaxation curve obtained from the pulse NMR measurement is optimized by a nonlinear least-squares method by applying a Gauss function to a component having the shortest relaxation time and a Lorenz function to the other components, and a weighted average of each spin-spin relaxation time T2 is defined as the spin-spin relaxation time T2 according to the present invention.

<Introduction of Ion into Electroonductive Resin Layer>

As a method of introducing ions into the binder resin forming the electroconductive resin layer, for example, the following method can be used.

(I) An ion conducting agent formed of an anion and a cation is added to a resin for forming an electroconductive resin layer, for example, a binder resin to prepare a composition for forming an electroconductive resin layer, and an electroconductive resin layer is formed at a predetermined position of an outer periphery of an electroconductive mandrel through use of the composition.

(II) An ion conducting agent formed of an anion and a cation is added to a raw material component such as a monomer component for forming a resin for forming an electroconductive resin layer, for example, a binder resin, and the mixture is allowed to react to prepare a binder resin in which the anion is contained in the resin having the cation chemically bound thereto. An electroconductive resin layer is formed at a predetermined position of an outer periphery of an electroconductive mandrel through use of the binder resin.

In order to form the electroconductive resin layer, a known forming method such as extrusion molding, injection molding, or compression forming, and a known coating method such as a spray coating method, a dipping method, a roll coating method, or a bar coating method can be used. Further, the electroconductive resin layer can be arranged on an outer peripheral surface of the mandrel by a method involving forming a member to be the electroconductive resin layer in advance and bonding and fixing the member to a predetermined position of an outer periphery of the mandrel or a method involving forming the electroconductive resin layer on the outer peripheral surface of the mandrel. It should be noted that, even in the case where the electrophotographic member has, for example, a flat plate shape instead of a roll shape, various methods described above can be similarly used.

The addition amount of the ion conducting agent containing an oxalate complex anion with respect to the electroconductive resin layer can be appropriately set. It is preferred that the ion conducting agent be blended in the electroconductive resin layer at a ratio of 0.5 part by mass or more and 20 parts by mass or less with respect to 100 parts by mass of the binder resin. In the case where the blending amount of the ion conducting agent is 0.5 part by mass or more, the effect of imparting an electroconductive property by adding the conducting agent can be easily obtained. In the case where the blending amount is 20 parts by mass or less, the dependency of electric resistance on an environment can be reduced.

Now, the formation of the electroconductive resin layer by the method (II) is described.

It is preferred that a cationic group be bound and fixed to a molecular structure of the binder resin. When a cationic group such as a quaternary ammonium cation is linked to the binder resin through chemical binding, the exudation of ions from the electroconductive resin layer can be suppressed effectively.

The binder resin having a cationic group linked thereto through chemical binding can be produced, for example, by the following method through use of (A) an ion conducting agent for binding a binder resin and (B) a binder resin or a raw material for forming the binder resin.

(A) Ion Conducting Agent for Binding Resin

As an ion conducting agent for binding a resin, for example, the ion conducting agent including a combination of an oxalate complex anion and a cation having a reactive functional group for binding to a binder resin is used. Examples of the reactive functional group for binding to a binder resin include a halogen atom (a fluorine atom, a chlorine atom, a bromine atom, and an iodine atom), a carboxyl group, an acid group such as an acid anhydride, a hydroxyl group, an amino group, a mercapto group, an alkoxy group, a vinyl group, a glycidyl group, an epoxy group, a nitrile group, and a carbamoyl group. Any of the reactive functional groups may be used as long as the group reacts with the resin to allow the intended fixation of the cation.

The anion for binding a resin can be introduced into the ion conducting agent through use of an ion-exchange reaction between a salt of an oxalate complex anion and a cation compound having a reactive functional group.

For example, in the case where lithium bis(oxalato)borate is used as the salt of an oxalate complex anion and glycidyltrimethylammonium chloride is used as the cation compound having a reactive functional group, first, lithium bis(oxalato)borate and glycidyltrimethylammonium chloride are separately dissolved in purified water to provide two kinds of aqueous solutions. When the two kinds of aqueous solutions thus obtained are mixed and stirred, a chlorine ion having a high ion-exchange property is substituted by an bis(oxalato)borate ion through the ion-exchange reaction. In this case, the generated glycidyltrimethylammonium/bis(oxalato)borate ion is an ionic liquid exhibiting hydrophobicity, and hence water-soluble lithium chloride, which is a by-product, can be removed easily from the generated ionic liquid.

(B) Resin for Fixing Cation

There is no particular limitation on a resin for fixing a cation as long as the resin can be used for forming the electroconductive resin layer and fixes a cation contained in the above-mentioned ion conducting agent through a reaction with a reactive functional group of the cation. Such resin can be selected and used from those having reactivity with a functional group introduced into a cation among various resins described in the “(2) Resin for Forming Electroonductive Resin Layer” section.

Examples of the reactive functional group include an acid group such as an isocyanate group, a carboxyl group, and an acid anhydride, a hydroxyl group, an amino group, a mercapto group, an alkoxy group, a vinyl group, a glycidyl group, an epoxy group, a nitrile group, and a carbamoyl group. Any of those groups may be used as long as the group reacts with the cation of the present invention to enable intended cation fixing.

As a preferred method of fixing a cation of an ion conducting agent to a resin, there is given a method involving adding an ion conducting agent to a raw material for forming a resin and allowing the mixture to react to form an electroconductive resin layer. Examples of the raw material for forming a resin to be used in this method include compounds having two or more reactive functional groups or compounds that are polymerizable by themselves, such as a polyglycidyl compound, a polyamine compound, a polycarboxy compound, a polyisocyanate compound, a polyhydric alcohol compound, a polyisocyanate compound, a phenol compound, and a vinyl compound, and the raw material may be appropriately selected and used in accordance with the kind of an intended binder resin.

As a method of introducing and fixing a cation of an ion conducting agent to a resin, methods other than the above-mentioned method of producing a resin through use of an ion conducting agent can also be used. For example, it is also possible to use a method involving producing a resin through use of an ion conducting agent formed of an ion-exchangeable anion and a cation having a reactive functional group and introducing an oxalate complex anion into the resin through ion exchange. As the ion-exchangeable anion in this method, a proton or a halogen ion can be used. Further, the cation fixed to the binder resin serves as an ion-exchange group.

It can be confirmed whether or not the ion-exchange group is linked to the resin through a chemical structure by the following method. A part of an electroconductive resin layer is cut out as a measurement sample. The measurement sample is subjected to Soxhlet extraction through use of a hydrophilic solvent such as ethanol for 1 week. The measurement sample after the extraction is subjected to infrared (IR) spectroscopy, and thus the presence/absence of the linking of the ion-exchange group can be confirmed. Similarly, the obtained extract and the measurement sample after the extraction treatment are subjected to solid ¹³C-NMR measurement and mass analysis using a time-of-flight mass spectrometer (TOF-MS), and thus an ion-exchange group species and an ion-exchange group amount can be measured.

<Other Components>

A filler, a softening agent, a processing aid, a tackifier, an antitack agent, a dispersant, a foaming agent, roughness-providing particles, or the like generally used as a compounding agent for a binder resin can be added to the electroconductive resin layer according to the present invention in such a range that the effects of the present invention are not impaired.

<Electroconductive Roller>

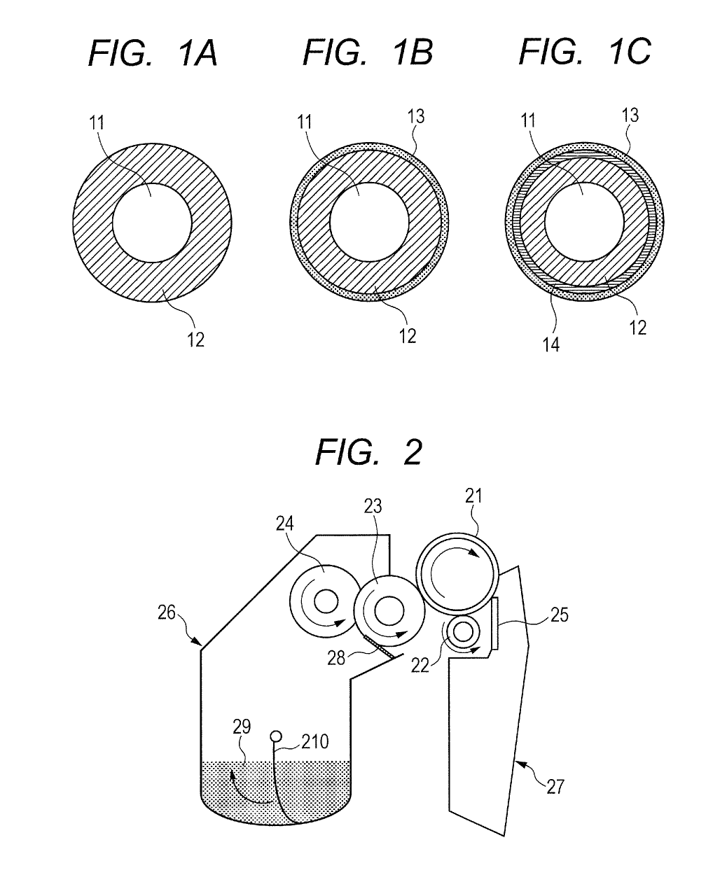

FIG. 1A, FIG. 1B, and FIG. 1C are schematic views for illustrating a charging roller as an electrophotographic member according to one embodiment of the present invention. The charging roller may have a single-layer configuration including a cored bar 11 serving as a mandrel and an elastic layer 12 formed on an outer periphery of the cored bar 11 as illustrated in FIG. 1A or may have a two-layer configuration in which a surface layer 13 is arranged on an outer side of the elastic layer 12 as illustrated in FIG. 1B.

In the single-layer configuration illustrated in FIG. 1A, the elastic layer 12 is the electroconductive resin layer containing the ion conducting agent according to the present invention. In the case of the structure illustrated in FIG. 1B, at least one of the elastic layer 12 or the surface layer 13 is the electroconductive resin layer containing the ion conducting agent according to the present invention. Further, as necessary, another electroconductive layer may be combined with the structure in such a range that the effects of the present invention are not impaired. Further, the charging roller may have a multi-layer configuration in which some intermediate layers or adhesive layers are arranged between the elastic layer 12 and the surface layer 13 as illustrated in FIG. 1C. In this case, in the same manner as in the foregoing, at least any one of the layers is the electroconductive resin layer containing the ion conducting agent according to the present invention.

A guideline of the electric resistance value of the layers to be formed on the outer peripheral surface of the cored bar 11 is 1×10³ Ω·cm or more and 1×10⁹ Ω·cm or less. In particular, it is preferred that the electric resistance value of the electroconductive resin layer containing the ion conducting agent according to the present invention be 1×10⁵ Ω·cm or more and 1×10⁸ Ω·cm or less. In the case where the layers to be formed on the outer peripheral surface of the cored bar 11 have a configuration of a plurality of layers and the electric resistance value of the electroconductive resin layer containing the ion conducting agent according to the present invention is set to 1×10⁵ Ω·cm or more, the occurrence of abnormal discharge caused by leakage can be suppressed as long as the electric resistance value of the other layers is 1×10³ Ω·cm or more and 1×10⁹ Ω·cm or less. In the case where the electric resistance value of the electroconductive resin layer containing the ion conducting agent according to the present invention is set to 1×10⁸ Ω·cm or less, the occurrence of image defects caused by the shortage of electric resistance can be suppressed as long as the electric resistance value of the other layers is 1×10³ Ω·cm or more and 1×10⁹ Ω·cm or less. A guideline of the layer thickness of the electroconductive resin layer is 100 nm or more and 2,000 μm or less.

In particular, it is preferred that the electroconductive resin layer according to the present invention be used as the surface layer 13 and the layer thickness thereof be 3 μm or more and 40 μm or less. It is preferred that the surface layer of the electroconductive resin layer according to the present invention be used as a surface layer of an electronic conductive elastic layer in an electroconductive roller because an environmental fluctuation difference in electric characteristics between the L/L environment and the H/H environment as the entire electroconductive roller is small and a high electroconductive property can be achieved. In the case where the layer thickness of the surface layer 13 is set to 3 μm or more, a change in electroconductivity due to continuous electricity supply of the electroconductive roller can be suppressed. Further, a high electroconductive property as the electroconductive roller can be maintained by setting the layer thickness of the surface layer 13 to 40 μm or less.

In the case where the electroconductive resin layer containing the ion conducting agent according to the present invention is used as the surface layer 13 of the elastic layer 12 as illustrated in FIG. 1B, there is no particular limitation on a rubber component forming the elastic layer 12, and a rubber known in the field of electrophotographic electroconductive members can be used. Specific examples thereof include an epichlorohydrin homopolymer, an epichlorohydrin-ethylene oxide copolymer, an epichlorohydrin-ethylene oxide-allyl glycidyl ether terpolymer, an acrylonitrile-butadiene copolymer, a hydrogenated product of the acrylonitrile-butadiene copolymer, a silicone rubber, an acrylic rubber, and a urethane rubber.

In the case where the electroconductive resin layer containing the ion conducting agent according to the present invention is used as the elastic layer 12 or the intermediate layer 14 between the elastic layer 12 and the surface layer 13, a resin known in the field of electrophotographic electroconductive members can be used for forming the surface layer 13. Specific examples thereof include an acrylic resin, polyurethane, polyamide, polyester, polyolefin, and a silicone resin. For the resin for forming the surface layer as necessary, there may be used: carbon black; graphite; an oxide having an electroconductive property such as tin oxide; a metal such as copper or silver; electroconductive particles obtained by imparting an electroconductive property to particles by covering the surfaces of the particles with an oxide or a metal; and an ion conducting agent having ion-exchange performance such as a quaternary ammonium salt.

<Process Cartridge>

FIG. 2 is a schematic sectional view of an electrophotographic process cartridge according to one embodiment of the present invention.

The process cartridge can be configured to include at least one of a developing device or a charging device and other devices as necessary. The developing device includes at least a developing roller 23 and a toner container 26 integrated with each other, and as necessary, may include a toner supply roller 24, a toner 29, a developing blade 28, and a stirring blade 210. The charging device includes at least a photosensitive drum 21, a cleaning blade 25, and a charging roller 22 integrated with each other, and as necessary, may include a waste toner container 27. The charging roller 22, the developing roller 23, the toner supply roller 24, and the developing blade 28 are each designed to be supplied with a voltage, and the electrophotographic member according to the present invention is used for at least one of those components.

<Electrophotographic Apparatus>

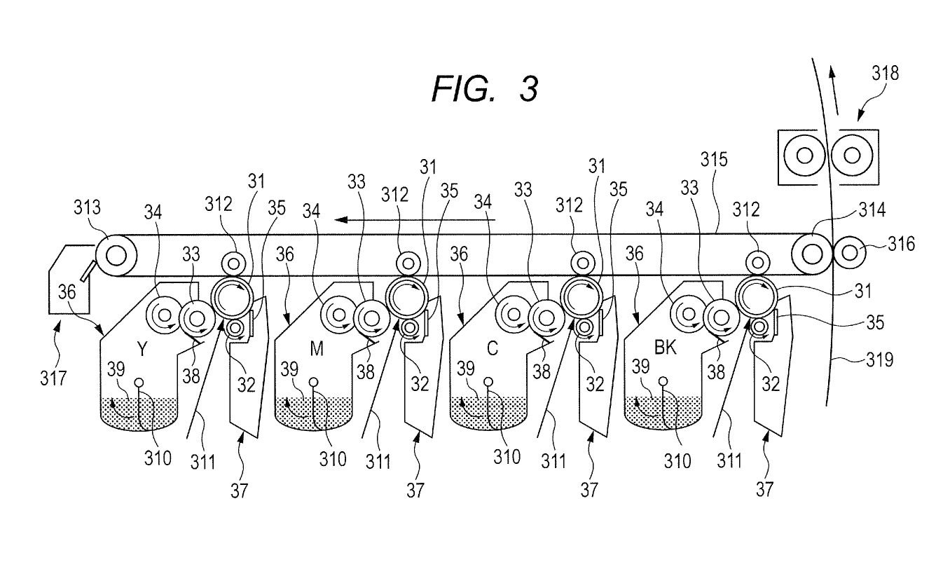

FIG. 3 is a schematic configuration view of an electrophotographic apparatus according to one embodiment of the present invention. The electrophotographic apparatus is, for example, a color image forming apparatus in which the process cartridge illustrated in FIG. 2 is provided for each of toners of four colors: black (BK), magenta (M), yellow (Y), and cyan (C) and the cartridges are removably mounted onto a main body of the apparatus.

A drum-shaped electrophotographic photosensitive member (hereinafter sometimes referred to as “photosensitive drum”) 31 is rotated in an arrow direction and uniformly charged by a charging roller 32 having a voltage applied thereto from a charging bias source. An electrostatic latent image is formed on a surface of the photosensitive drum 31 with exposure light 311. On the other hand, a toner 39 contained in a toner container 36 is supplied to a toner supply roller 34 by a stirring blade 310 and conveyed onto a developing roller 33. The toner 39 is uniformly applied onto a surface of the developing roller 33 with a developing blade 38 arranged in contact with the developing roller 33, and charge is given to the toner 39 by triboelectric charging. The electrostatic latent image is developed by being supplied with the toner 39 conveyed by the developing roller 33 arranged in contact with the photosensitive drum 31 and visualized as a toner image.

The visualized toner image on the photosensitive drum 31 is transferred onto an intermediate transferring belt 315, which is supported and driven by a tension roller 313 and an intermediate transferring belt drive roller 314, by a primary transferring roller 312 having a voltage applied thereto from a primary transfer bias source. The toner images of the respective colors are superimposed on each other to form a color image on the intermediate transferring belt 315.

A transfer material 319 is fed into the apparatus by a sheet feed roller and conveyed to between the intermediate transferring belt 315 and a secondary transferring roller 316. The secondary transferring roller 316 is supplied with a voltage from a secondary transfer bias source and transfers the color image on the intermediate transferring belt 315 onto the transfer material 319. The transfer material 319 having the color image transferred thereonto is subjected to fixing treatment by a fixing unit 318 and delivered out of the apparatus. Thus, a print operation is completed.

On the other hand, a toner remaining on the photosensitive drum 31 without being transferred is scraped off from a surface of the photosensitive drum 31 with a cleaning blade 35 and is stored in a waste toner storage container 37. The cleaned photosensitive drum 31 performs the above-mentioned steps repeatedly. Further, a toner remaining on the intermediate transferring belt 315 without being transferred is also scraped off with a cleaning device 317.

According to one embodiment of the present invention, the humidity environment dependency of the electric resistance of the electrophotographic member can be reduced significantly by incorporating a particular anion and a particular cation as a conducting agent into the electroconductive resin layer. That is, an excessive decrease in resistance in the H/H environment can be suppressed, and the electric resistance value in the L/L environment can be reduced.

Further, according to one embodiment of the present invention, a process cartridge and an electrophotographic apparatus capable of forming an electrophotographic image of high quality can be provided by using the above-mentioned electrophotographic member.

### EXAMPLES

### Example 1

### 1. Preparation of Unvulcanized Rubber Composition

Each material of a type and an amount shown in Table 1 below was mixed with a pressure kneader to obtain an A-kneaded rubber composition. Further, 177 parts by mass of the A-kneaded rubber composition and each material of a type and an amount shown in Table 2 below were mixed with an open roll to prepare an unvulcanized rubber composition.

TABLE 1

| | | Blending amount |
|---|---|---|
| | Materials | (part(s) by mass) |
| Raw material | NBR (trade name: Nipol DN219; | 100 |
| rubber | manufactured by Zeon Corporation) | |
| Conducting | Carbon black (trade name: | 40 |
| agent | TOKABLACK #7360SB; manu- | |
| | factured by Tokai Carbon Co., | |
| | Ltd.) | |
| Filler | Calcium carbonate (trade name: | 20 |
| | NANOX #30; manufactured | |
| | by Maruo Calcium Co., Ltd.) | |
| Vulcanization | Zinc oxide | 5 |
| accelerator aid | | |
| Processing aid | Stearic acid | 1 |

TABLE 2

| | | Blending amount |
|---|---|---|
| | Materials | (part(s) by mass) |
| Cross-linking | Sulfur | 1.2 |
| agent | | |
| Vulcanization | Tetrabenzylthiuram disulfide | 4.5 |
| accelerator | (trade name: TBZTD; manu- | |
| | factured by Sanshin Chemical | |
| | Industry Co., Ltd.) | |

### 2. Manufacturing of Electroconductive Elastic Roller

A round bar having a total length of 252 mm and an outer diameter of 6 mm obtained by subjecting a surface of free-cutting steel to electroless nickel plating was provided. Then, an adhesive was applied to an entire periphery of the round bar in a range of 230 mm excluding each end portion of 11 mm. As the adhesive, an electroconductive hot-melt type adhesive was used. Further, a roll coater was used for the application of the adhesive. In this example, the round bar having the adhesive applied thereto was used as an electroconductive mandrel.

Next, a crosshead extruder having a supply mechanism of the electroconductive mandrel and a discharge mechanism of the unvulcanized rubber roller was provided. A die having an inner diameter of 12.5 mm was mounted on the crosshead. The extruder and the crosshead were adjusted to 80° C., and the conveyance speed of the electroconductive mandrel was adjusted to 60 mm/sec. Under this condition, the unvulcanized rubber composition was supplied through the extruder, and an outer peripheral surface of the electroconductive mandrel was covered with the unvulcanized rubber composition as an elastic layer in the crosshead. Thus an unvulcanized rubber roller was obtained. Then, the unvulcanized rubber roller thus obtained was placed in a hot-air vulcanizing furnace at 170° C. and heated for 60 minutes to obtain an unpolished electroconductive elastic roller. After that, end portions of the elastic layer were cut to be removed. Finally, a surface of the elastic layer was polished with a grindstone. Thus, an electroconductive elastic roller was obtained in which each diameter at a position of 90 mm from a center portion to each end portion was 8.4 mm and a diameter of the center portion was 8.5 mm.

<Synthesis of Ion Conducting Agent>

5 g (25.9 mmol) of lithium bis(oxalato)borate (manufactured by Sigma-Aldrich Japan K.K.) was dissolved in ml of purified water. Then, 4.29 g (25.9 mmol) of tetraethylammonium chloride was dissolved in 50 ml of purified water. Next, two kinds of the aqueous solutions thus obtained were mixed and stirred for 2 hours. After the mixing and stirring, the resultant was allowed to stand still overnight. As a result, the resultant was separated into two layers: a water layer as an upper layer liquid in which lithium chloride as a reaction by-product was dissolved and an oil layer as a lower layer liquid formed of tetraethylammonium bis(oxalato)borate. The oil layer was collected through use of a separating funnel, and the collected oil layer was washed with purified water twice so as to remove a small amount of lithium chloride remaining in the oil layer. Tetraethylammonium bis(oxalato)borate was obtained by the above-mentioned method.

Further, lithium tris(oxalato)phosphate was synthesized by the following method.

756 g (8.4 mol) of oxalic acid anhydride (manufactured by Kanto Chemical Co., Inc.) and 1 L of diethyl ether were placed in a 2-L flask equipped with a Dimroth condenser and stirred at a temperature of from 20° C. to 25° C. for 10 minutes. After that, 564 g (2.71 mol) of phosphorus pentachloride (manufactured by Tokyo Chemical Industry Co., Ltd.) was added to the resultant over 90 minutes. In this case, heat was generated due to reaction heat, and hence the reaction system was cooled to a temperature of from 20° C. to 30° C. After the addition of 150 g of phosphorus pentachloride to the reaction solution, a gas of hydrogen chloride was generated to decrease the temperature, and hence the reaction system was heated to 20° C. or more. After the completion of the generation of hydrogen chloride, the reaction system was heated to a temperature of from 40° C. to 43° C. to be refluxed for 2 hours. Ether was evaporated under reduced pressure, followed by drying, and a solid thus obtained was washed with diethyl ether. The resultant was dried under reduced pressure at room temperature to obtain 910 g of a tris(oxalato)phosphate/diethyl ether complex as a white solid (yield: 75%)

Next, 250 g (0.56 mol) of the tris(oxalato)phosphate/diethyl ether complex obtained in the foregoing was dispersed in 500 ml of diethyl ether in a 1-L flask equipped with a Dimroth condenser. 5.6 g (0.71 mol) of lithium hydride (manufactured by Kanto Chemical Co., Inc.) was added to the resultant, followed by stirring at room temperature. After the generation of hydrogen through the reaction stopped, the resultant was refluxed for 3 hours, and consequently the generation of hydrogen was further observed. The resultant mixture was dried under reduced pressure at 80° C. to obtain 160 g to 175 g of a crude product. In order to purify the crude product, the crude product was dissolved in diethyl carbonate so as to obtain a 30 mass % solution. In this case, lithium hydride and the other impurities were insoluble in diethyl carbonate and hence were removed by filtering. The filtrate was distilled away under reduced pressure to precipitate a colorless crystal in a concentration of 35 mass % or more. The crystal was collected by filtering and dried to obtain 85 g of lithium tris(oxalato)phosphate.

Next, 7.6 g (25.9 mmol) of lithium tris(oxalato)phosphate was dissolved in 50 ml of purified water. Then, 4.29 g (25.9 mmol) of tetraethylammonium chloride was dissolved in 50 ml of purified water. Next, two kinds of the aqueous solutions thus obtained were mixed and stirred for 2 hours. After the mixing and stirring, the resultant was allowed to stand still overnight. As a result, the resultant was separated into two layers: a water layer as an upper layer liquid in which lithium chloride as a reaction by-product was dissolved and an oil layer as a lower layer liquid formed of tetraethylammonium tris(oxalato)phosphate. The oil layer was collected through use of a separating funnel, and the collected oil layer was washed with purified water twice so as to remove a small amount of lithium chloride remaining in the oil layer. Tetraethylammonium tris(oxalato)phosphate was obtained by the above-mentioned method.

### 3. Preparation of Application Liquid 1

An application liquid of a binder resin for forming the electroconductive resin layer according to the present invention was prepared by the following procedure.

<Synthesis of Isocyanate Group-terminated Prepolymer 1>

A component A below was provided in a reaction vessel in a nitrogen atmosphere, and a component B below was gradually dropped to the component A while the temperature in the reaction vessel was held at 65° C.

A: polymeric MDI (trade name: MILLIONATE MR200; manufactured by Nippon Polyurethane Industry Co., Ltd.): 27 parts by mass
B: polypropylene glycol having a molecular weight of 1,000, in which propylene oxide is added to glycerin (trade name: EXCENOL 1020; manufactured by Asahi Glass Co., Ltd.): 100 parts by mass

After the completion of the dropping, the resultant was reacted at a temperature of 65° C. for 2 hours. The reaction mixture thus obtained was cooled to room temperature to obtain an isocyanate group-terminated prepolymer 1 having an isocyanate group content of 3.31%.

(Preparation of Application Liquid 1)

The following components were mixed under stirring:

isocyanate group-terminated prepolymer 1: 60.4 parts by mass;

polyether diol having a molecular weight of 2,000, in which ethylene oxide is addition-polymerized with polypropylene glycol (trade name: PTG2000; manufactured by Hodogaya Chemical Co., Ltd.): 40.6 parts by mass; and

tetraethylammonium bis(oxalato)borate: 2 parts by mass.

Next, methyl ethyl ketone (hereinafter referred to as “MEK”) was added to the mixture thus obtained so as to achieve a total solid ratio of 30 mass %, and thereafter the resultant was mixed with a sand mill. Then, the resultant mixture was further adjusted to a viscosity of 12 cps with MEK to prepare an application liquid 1.

### 4. Manufacturing of Electroconductive Roller

The electroconductive elastic roller manufactured in the section 2 was dipped once in the application liquid 1 prepared by the procedure in the section 3 and air-dried at 23° C. for 30 minutes. Then, the electroconductive elastic roller was dried in a hot-air circulation drier set to 90° C. for 1 hour, and further dried in a hot-air circulation drier set to 160° C. for 3 hours. Thus, an electroconductive resin layer was formed on an outer peripheral surface of the electroconductive elastic roller. The dip coating immersion time was set to 9 seconds, and the dip coating lifting speed was adjusted so that an initial speed became 20 mm/sec and a final speed became 2 mm/sec. Between 20 mm/sec and 2 mm/sec, the dip coating lifting speed was linearly changed with respect to time.

An electroconductive roller of Example 1 was manufactured by the above-mentioned procedure.

### 5. Evaluation of Characteristics

Next, the electroconductive roller thus obtained was subjected to the following evaluation tests. The evaluation results are shown in Table 6.

<5-1. Measurement of Electric Resistance of Electroconductive Resin Layer>

The electric resistivity of the electroconductive resin layer was calculated from a measurement value obtained by AC impedance measurement using a four-point probe method. The AC impedance measurement was conducted at an application voltage of 50 mV and a measurement frequency of from 1 Hz to 1 MHz. As a four-point probe, MCT-TP06P manufactured by Mitsubishi Chemical Corporation was used (probe distance: 4.5 mm).

The electric resistance was measured in an environment having a temperature of 15° C. and a relative humidity of 10% RH and an environment having a temperature of 30° C. and a relative humidity of 80% RH. Further, in order to confirm the influence of an environmental fluctuation, a logarithm of a ratio between an electric resistivity in an environment having a temperature of 15° C. and a relative humidity of 10% RH and an electric resistivity in an environment having a temperature of 30° C. and a relative humidity of 80% RH was taken and defined as an environmental fluctuation digit. It should be noted that the electroconductive roller was subjected to the measurement after being left to stand in each environment for 72 hours or more. In the case where the electroconductive resin layer to be measured was an outermost surface layer of the electroconductive roller, the four-point probe was pressed against a surface of the electroconductive roller in parallel with the cored bar to measure an electric resistivity. It should be noted that the measurement of an electric resistivity was conducted five times, and an average value of the five measurements was defined as the electric resistivity of the present invention.

In the case where the electroconductive resin layer to be measured was an intermediate layer, an outermost surface layer was removed with a razor to expose the intermediate layer, and thereafter, the four-point probe was similarly pressed against the surface of the electroconductive roller to measure an electric resistivity.

<5-2. Evaluation of Relaxation Time T2 of Electroconductive Resin Layer>

For the measurement of a spin-spin relaxation time T2 of the electroconductive resin layer, a pulse NMR device (trade name: MU25A, manufactured by JEOL Ltd.) was used. 0.5 g of the electroconductive resin layer of the electroconductive roller, which was left to stand in an environment having a temperature of 15° C. and a relative humidity of 10% RH for 72 hours, was shaved off to be used as a test sample. The test sample was sealed in a measurement cell and measured for a relaxation time T2. The value of the relaxation time T2 with a hydrogen nucleus as a measurement nucleus is determined by pulse NMR measurement based on an echo intensity obtained by a solid echo method. The measurement conditions were a measurement frequency of 20 MHz, a 90° pulse width of 2.0 μsec, a pulse interval of 12 μsec, a temperature of 15° C., and a cumulated number of 128.

<5-3. Evaluation of Bleed>

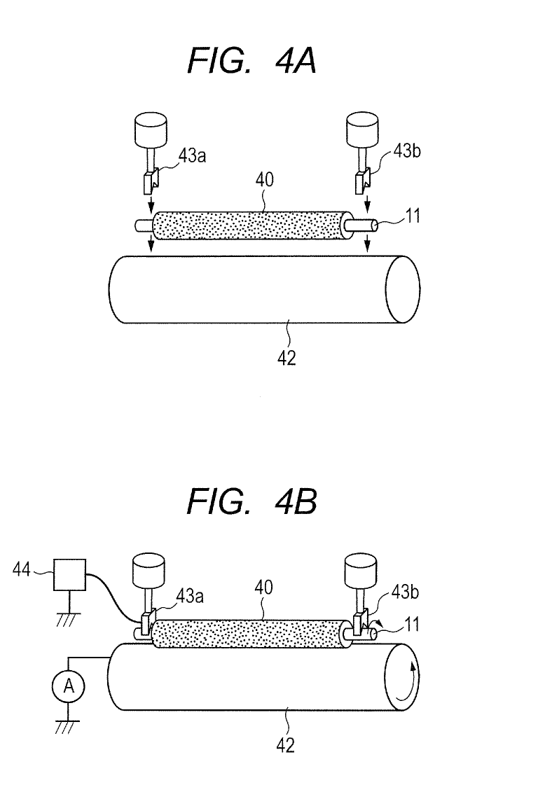

Next, a bleed test was conducted through use of a current measuring instrument illustrated in FIG. 4A and FIG. 4B.

As illustrated in FIG. 4A and FIG. 4B, an electroconductive roller 40 and a photosensitive drum 42 having a diameter of 24 mm were arranged so as to be opposed to each other. In this case, as the photosensitive drum 42, an organic photosensitive drum removed from a process cartridge for an electrophotographic laser printer (trade name: Laserjet CP4525dn, manufactured by Hewlett Packard Company) was used.

Then, in an environment having a temperature of 40° C. and a relative humidity of 95% RH, the electroconductive roller 40 was brought into abutment against the photosensitive drum 42 with a load (500 gf on one side) of pressing the electroconductive roller 40 in a vertically downward direction being applied to both ends of a mandrel 11 and left to stand for 2 weeks without being rotated. After that, the surface of the photosensitive drum 42 was observed with an optical microscope (magnification power: 10 times). The presence/absence of the adhesion of a bled substance from the electroconductive roller 40 and the presence/absence of a crack on the surface of the photosensitive drum 42 were visually observed and evaluated based on the following criteria.

Rank A: The adhesion of a bled substance is not recognized on the surface of an abutment portion of the photosensitive drum.

Rank B: The adhesion of a bled substance is slightly recognized in a part of the surface of an abutment portion of the photosensitive drum.

Rank C: The adhesion of a bled substance is recognized on the entire surface of an abutment portion of the photosensitive drum.

Rank D: A crack caused by a bled substance is recognized on the surface of an abutment portion of the photosensitive drum.

### 6. Evaluation of Image

Next, the manufactured electroconductive roller was subjected to the following evaluation tests. The evaluation results are shown in Table 7.

<6-1. Pinhole Leak Test>

In order to confirm the effect of the electroconductive roller of suppressing an excessive decrease in resistance in the H/H environment, the electroconductive roller was incorporated as a charging roller into an electrophotographic apparatus and subjected to the following evaluation of an image.

First, the manufactured electroconductive roller was left to stand in an environment having a temperature of 30° C. and a relative humidity of 80% RH for 72 hours or more. Next, as an electrophotographic apparatus, an electrophotographic laser printer (trade name: Laserjet CP4525dn, manufactured by Hewlett Packard Company) remodeled for a high speed of an A4 sheet output number of 50 per minute was provided. In this case, the output speed of recording media was set to 300 mm/sec, and the image resolution was set to 1,200 dpi. Then, a photosensitive drum in a cartridge of the electrophotographic apparatus was removed, and a pinhole having a diameter of 0.3 mm was formed at one position of a surface of the photosensitive drum in a direction perpendicular to a rotation axis of the photosensitive drum.

The electroconductive roller to be evaluated was incorporated as a charging roller into the cartridge of the electrophotographic apparatus in combination with the photosensitive drum having the pinhole. Further, an external power source (trade name: Trek615-3, manufactured by Trek Japan Co., Ltd.) was provided so as to apply a DC voltage of −1,500 V to the charging roller. Thus, the evaluation of an image was performed.

The evaluation of an image was all performed in an environment having a temperature of 30° C. and a relative humidity of 80% RH by outputting five half-tone images (image drawing a horizontal line with a width of 1 dot and an interval of 2 dots in a direction perpendicular to a rotation direction of the photosensitive drum). In this case, when a portion having image density significantly different from that of the periphery was formed in a direction horizontal to the image output direction from a position in an image corresponding to the position of the pinhole on the photosensitive drum, it was determined that an image failure such as a pinhole leak occurred. The obtained images were evaluated based on the following criteria.

A: No pinhole leak is observed in the five images.

B: A pinhole leak occurs at one to three positions in the five images.

C: A pinhole leak occurs at a photosensitive drum cycle in the five images.

<6-2. Evaluation of Streak-like Image Defect>

The discharge characteristics of the electroconductive roller serving as a charging roller after an electricity supply were evaluated by the following procedure through use of the device illustrated in FIG. 4A and FIG. 4B used in the evaluation according to the section 5-3.

First, the manufactured electroconductive roller was left to stand in an environment having a temperature of 15° C. and a relative humidity of 10% RH for 72 hours. Then, electricity supply deterioration jigs illustrated in FIG. 4A and FIG. 4B were provided in an environment having a temperature of 15° C. and a relative humidity of 10% RH. An outer peripheral surface of the electroconductive roller 40 was pressed against the columnar metal body 42 having a diameter of 30 mm with a load being applied to both ends of the electroconductive mandrel 11 of the electroconductive roller 40 through electroconductive bearings 43a and 43b of the electricity supply deterioration jigs. In this state, the columnar metal body 42 was rotated at 30 rpm so that the electroconductive roller 40 was driven to be rotated by the rotation of the columnar metal body 42. Then, a DC current of 200 μA was applied to the electroconductive roller 40 by a power source 44 for 30 minutes. After that, the evaluation of an image was performed by the following procedure.

As an electrophotographic apparatus, an electrophotographic laser printer (trade name: Laserjet CP4525dn, manufactured by Hewlett Packard Company) remodeled for a high speed of an A4 sheet output number of 50 per minute was provided. In this case, the output speed of recording media was set to 300 mm/sec, and the image resolution was set to 1,200 dpi. The electroconductive roller subjected to electricity supply treatment was incorporated as a charging roller into a cartridge of the electrophotographic apparatus, and the evaluation of an image was performed. The evaluation of an image was all performed in an environment having a temperature of 15° C. and a relative humidity of 10% RH by outputting half-tone images (image drawing a horizontal line with a width of 1 dot and an interval of 2 dots in a direction perpendicular to a rotation direction of the photosensitive drum). The obtained images were evaluated based on the following criteria.

A: No horizontal streak-like image is observed.

B: A slight horizontal streak-like white line is observed in a part of a surface.

C: A slight horizontal streak-like white line is observed on an entire surface.

D: A significant horizontal streak-like white line is observed and conspicuous.

### Examples 2 to 12

Electroconductive rollers were manufactured and evaluated in the same manner as in Example 1 except for using application liquids 2 to 12 having compositions shown in Table 4 respectively instead of the application liquid 1. It should be noted that the details of anions, cations, and binder resin raw materials shown in Table 4 are shown in Table 3. The evaluation results are shown in Table 6.

TABLE 3
Anion

| | |
|---|---|
| A | Bis(oxalato)borate ion |
| B | Tris(oxalato)phosphate ion |
| C | Bromine ion |

Cation

| | |
|---|---|
| A | Tetraethylammonium |
| B | 1-Methyl-3-butylimidazolium |
| C | Choline |
| D | 1-(2-Hydroxyethyl)2-methylimidazolium |

Binder resin as raw material

| | |
|---|---|
| A | Isocyanate curing agent (trade name: Millionate MR-200, |
| | manufactured by Nippon Polyurethane Industry Co., Ltd.) |
| B | Polytetramethylene glycol (trade name: PTG2000, |
| | manufactured by Hodogaya Chemical Co., Ltd.) |
| C | Polytetramethylene glycol (trade name: PTG1000, |
| | manufactured by Hodogaya Chemical Co., Ltd.) |
| D | Polytetramethylene glycol (trade name: PTG3000, |
| | manufactured by Hodogaya Chemical Co., Ltd.) |
| E | Both-terminal-silanol-modified silicone oil (trade |
| | name: X-21-5841, manufactured by Shin-Etsu Silicones) |

TABLE 4

| | Application | Application | Application | Application | Application | Application | Application |
|---|---|---|---|---|---|---|---|
| | liquid 1 | liquid 2 | liquid 3 | liquid 4 | liquid 5 | liquid 6 | liquid 7 |
| Ion conducting agent | A | A | A | A | B | B | B |
| Anion species | | | | | | | |
| Cation species | A | B | C | D | A | B | C |
| Addition amount of | 2 | 2 | 2 | 2 | 2 | 2 | 2 |
| ion conducting agent | | | | | | | |
| (parts by mass) | | | | | | | |
| Binder resin raw | A/B | A/B | A/B | A/B | A/B | A/B | A/B |
| material | | | | | | | |
| Addition amount | 100/40. 6 | 100/40.6 | 100/40.6 | 100/40.6 | 100/40.6 | 100/40.6 | 100/40.6 |
| of binder resin | | | | | | | |
| (number of parts | | | | | | | |
| by mass) | | | | | | | |

| | Application | Application | Application | Application | Application | Application | Application | Application |
|---|---|---|---|---|---|---|---|---|
| | liquid 8 | liquid 9 | liquid 10 | liquid 11 | liquid 12 | liquid 13 | liquid 14 | liquid 15 |
| Ion conducting agent | B | A | A | A | B | A | A | A |
| Anion species | | | | | | | | |
| Cation species | D | C | C | C | C | C | A | C |
| Addition amount of | 2 | 2 | 2 | 2 | 2 | 2 | 2 | 2 |
| ion conducting agent | | | | | | | | |
| (parts by mass) | | | | | | | | |
| Binder resin raw | A/C | A/C | A/D | A/E | A/E | A/B | A/B | A/C |
| material | | | | | | | | |
| Addition amount | 100/40.6 | 100/33.8 | 100/48.7 | 100/58.2 | 100/58.2 | 100/40.6 | 100/40.6 | 100/33.8 |
| of binder resin | | | | | | | | |
| (parts by mass) | | | | | | | | |

### Example 13

An electroconductive roller was manufactured and evaluated in the same manner as in Example 1 except for using an electroconductive elastic roller manufactured from an unvulcanized rubber composition obtained by mixing materials shown in Table 5 below with an open roll and using an application liquid 13 shown in Table 4. The evaluation results are shown in Table 6.

TABLE 5

| | | |
|---|---|---|
| Epichlorohydrin-ethylene oxide-allyl glycidyl | 100 | parts by mass |
| ether terpolymer (GECO) (trade name: | | |
| EPICHLOMER CG-102, manufactured by Daiso | | |
| Co., Ltd.) | | |
| Zinc oxide (zinc oxide Type II, manufactured by | 5 | parts by mass |
| Seido Chemical Industry Co., Ltd.) | | |
| Calcium carbonate (trade name: Silver-W, | 35 | parts by mass |
| manufactured by Shiraishi Calcium Kaisha, Ltd.) | | |
| Carbon black (trade name: SEAST SO, | 0.5 | part by mass |
| manufactured by Tokai Carbon Co., Ltd.) | | |
| Stearic acid | 2 | parts by mass |
| Adipic acid ester (trade name: | 10 | parts by mass |
| POLYCIZER W305ELS, manufactured | | |
| by Dainippon Ink and Chemicals) | | |
| Sulfur | 0.5 | part by mass |
| Dipentamethylenethiuram tetrasulfide | 2 | parts by mass |
| (trade name: NOCCELER TRA, manufactured by | | |
| Ouchi Shinko Chemical Industrial Co., Ltd.) | | |
| Cetyltrimethylammonium bromide | 2 | parts by mass |

### Example 14

An electroconductive roller was manufactured in the same manner as in Example 13 except for using an application liquid 14 shown in Table 4. Next, a protective layer was formed on the electroconductive resin layer by the following method.

Methyl isobutyl ketone was added to a caprolactone-modified acrylic polyol solution to adjust a solid content to 10 mass %. Each component in a ratio shown below was added to 100 parts by mass of the solid content of the acrylic polyol solution to prepare a mixed solution.

Carbon black (HAF): 15 parts by mass

Needle-like rutile-type titanium oxide fine particles: 35 parts by mass

Modified dimethylsilicone oil: 0.1 part by mass

A 7:3 mixture of a butanone oxime-blocked product of hexamethylene diisocyanate (HDI) and a butanone oxime-blocked product of isophorone diisocyanate (IPDI): 80.14 parts by mass

In this case, each component was added to the acrylic polyol solution so that a mixture containing the HDI-containing blocked product and the IPDI-containing blocked product satisfied “NCO/OH=1.0”.

210 g of the mixed solution thus obtained and 200 g of glass beads having an average particle diameter of 0.8 mm serving as media for dispersion were mixed in a 450 mL glass bottle, and the mixture was subjected to dispersion treatment over 24 hours through use of a paint shaker dispersing machine. After the dispersion treatment, 5.44 parts by mass (amount equivalent to 20 parts by weight with respect to 100 parts by weight of an acrylic polyol) of cross-linking type acrylic particles (trade name: MR50G, manufactured by Soken Chemical & Engineering Co., Ltd.) were added as resin particles to a dispersion liquid separated from the glass beads, and further the resultant was subjected to dispersion treatment for 30 minutes to obtain a paint for forming a protective layer.

The paint for forming a protective layer thus obtained was applied onto an outer periphery of the electroconductive roller once by dip coating and air-dried at normal temperature for 30 minutes or more. Then, the electroconductive roller was dried in a hot-air circulation drier set to 90° C. for 1 hour and further dried in a hot-air circulation drier set to 160° C. for 1 hour. Thus, a protective layer was formed on the electroconductive resin layer of the electroconductive roller. The dip coating immersion time was set to 9 seconds, and the dip coating lifting speed was adjusted so that an initial speed became 20 mm/sec and a final speed became 2 mm/sec. Between 20 mm/sec and 2 mm/sec, the dip coating lifting speed was linearly changed with respect to time. The electroconductive roller thus obtained was evaluated in the same manner as in Example 1. The evaluation results are shown in Table 6.

### COMPARATIVE EXAMPLE

### Comparative Example 1

An electroconductive roller was manufactured in the same manner as in Example 1 except for using an application liquid 15 shown in Table 4 and evaluated in the same manner as in Example 1. The results are shown in Tables 6 and 9. Further, the thickness of a surface layer of this comparative example was 22 mm.

TABLE 6

| | Example 1 | Example 2 | Example 3 | Example 4 | Example 5 | Example 6 | Example 7 | Example 8 |
|---|---|---|---|---|---|---|---|---|
| Elastic layer | NBR | NBR | NBR | NBR | NBR | NBR | NBR | NBR |
| Surface layer | Application | Application | Application | Application | Application | Application | Application | Application |
| | liquid 1 | liquid 2 | liquid 3 | liquid 4 | liquid 5 | liquid 6 | liquid 7 | liquid 8 |
| Anion | A | A | A | A | B | B | B | B |
| Cation | A | B | C | D | A | B | C | D |
| Surface layer resistance | 4.3E+08 | 5.1E+08 | 1.5E+08 | 4.1E+08 | 8.2E+08 | 8.9E+08 | 4.9E+08 | 7.0E+08 |
| (Ω · cm) L/L | | | | | | | | |
| Surface layer resistance | 5.1E+06 | 6.2E+06 | 3.1E+06 | 5.9E+06 | 9.1E+06 | 8.3E+06 | 5.0E+06 | 7.7E+06 |
| (Ω · cm) H/H | | | | | | | | |
| T2 relaxation time (μsec) | 703 | 721 | 795 | 725 | 700 | 738 | 779 | 750 |
| Evaluation of bleed | B | B | A | A | B | B | A | A |
| Evaluation of image | | | | | | | | |
| Evaluation of pinhole leak | A | A | A | A | A | A | A | A |
| Evaluation of horizontal streak | B | B | A | A | B | B | A | A |

| | | | | | | | Comparative |
|---|---|---|---|---|---|---|---|
| | Example 9 | Example 10 | Example 11 | Example 12 | Example 13 | Example 14 | example 1 |
| Elastic layer | NBR | NBR | NBR | NBR | Hydrin | Hydrin | NBR |
| Surface layer | Application | Application | Application | Application | Application | Application | Application |
| | liquid 9 | liquid 10 | liquid 11 | liquid 12 | liquid 13 | liquid 14 | liquid 15 |
| Anion | A | A | A | B | A | A | C |
| Cation | C | C | C | C | C | A | A |
| Surface layer resistance | 1.3E+09 | 7.1E+07 | 8.3E+07 | 9.9E+07 | 1.5E+08 | 1.3E+07 | 9.7E+08 |
| (Ω · cm) L/L | | | | | | | |
| Surface layer resistance | 8.6E+06 | 1.3E+06 | 7.8E+06 | 9.0E+06 | 3.1E+06 | 3.1E+05 | 1.1E+07 |
| (Ω · cm) H/H | | | | | | | |
| T2 relaxation time (μsec) | 311 | 1,195 | 889 | 871 | 771 | 598 | 323 |
| Evaluation of bleed | B | C | A | A | A | A | C |
| Evaluation of image | | | | | | | |
| Evaluation of pinhole leak | A | B | A | A | A | A | A |
| Evaluation of horizontal streak | B | C | A | A | C | A | D |

### Example 15

Materials shown in Table 7 below were mixed to prepare an unvulcanized rubber composition. A cored bar of a stainless steel bar (electroconductive mandrel) having an outer diameter φ of 6 mm and a length of 258 mm was arranged in a mold, and the unvulcanized rubber composition was injected into a cavity formed in the mold.

TABLE 7

| | Blending amount |
|---|---|
| Material | (part(s) by mass) |
| Liquid silicone rubber (trade name: | 100 |
| SE6724A/B, manufactured by Dow Corning | |
| Toray Co., Ltd.) | |
| Carbon black (trade name: TOKABLACK | 28 |
| #7360SB, manufactured by Tokai Carbon | |
| Co., Ltd.) | |
| Silica powder | 0.2 |
| Platinum catalyst | 0.1 |

Next, the mold was heated at 120° C. for 8 minutes and then cooled to room temperature. After that, the cored bar was removed from the mold. Then, the cored bar was heated at 200° C. for 60 minutes to cure the unvulcanized rubber composition by vulcanization, and thus an elastic layer having a thickness of 3.0 mm was formed on an outer peripheral surface of the cored bar. An electroconductive roller according to Example 15 was obtained in the same manner as in Example 1 except for using an application liquid 3 shown in Table 4 on the elastic layer of the cored bar. The electroconductive roller was subjected to the following image formation test. The evaluation results are shown in Table 8.

<6-5. Evaluation of Fogging>

The manufactured electroconductive roller was mounted as a developing roller on a cartridge of a color laser printer (trade name: ColorLaserJet CP2025dn, manufactured by Hewlett-Packard Japan, Ltd.). As a toner, a magenta toner mounted in the cartridge was used as it was. The cartridge having the developing roller mounted thereon was left to stand in a low temperature/humidity (L/L) environment having a temperature of 15° C. and a relative humidity of 10% RH for 24 hours and was incorporated into the color laser printer that was left to stand in the same environment as that of the cartridge. In the same environment, images were output onto 6,000 sheets at a print percentage of 1%, and thereafter a solid white image was output onto one sheet of glossy paper.

An average value of reflecting densities of the output solid white image measured at 16 points (each center point of 16 cells formed by equally dividing the glossy paper into four in a vertical direction and four in a horizontal direction) was defined as Ds (%), and an average value of reflecting densities of the glossy paper before output of the solid white image measured at 16 points was defined as Dr (%), and Ds-Dr was defined as a fogging amount.

It should be noted that the reflecting densities were measured with a reflection densitometer (trade name: White Photometer TC-6DS/A, manufactured by Tokyo Denshoku Co., Ltd.). The fogging was evaluated as follows.

A: A fogging amount is less than 0.5%.

B: A fogging amount is 0.5% or more and less than 2%.

C: A fogging amount is 2% or more and less than 5%.

D: A fogging amount is 5% or more.

TABLE 8

| | Example 15 |
|---|---|
| Elastic layer | Silicone |
| Surface layer | Application liquid 3 |
| Anion | A |
| Cation | C |
| Surface layer resistance (Ω · cm) L/L | 1.5E+08 |
| Surface layer resistance (Ω · cm) H/H | 3.1E+06 |
| T2 relaxation time (μsec) | 795 |
| Evaluation of bleed | A |
| Evaluation of image | |
| Evaluation of fogging | A |

TABLE 9

| | Comparative Example 1 |
|---|---|
| Elastic layer | NBR |
| Surface layer | Application liquid 15 |
| Layer thickness of surface layer | 22 |
| Anion | C |
| Cation | A |
| Addition amount of ion conducting | 2 |
| agent (number of parts by mass) | |
| Binder resin raw material | A/C |
| Addition amount of binder resin | 100/33.8 |
| (number of parts by mass) | |
| Surface layer resistance (Ω · cm) | 9.7E+08 |
| L/L | |
| Surface layer resistance (Ω · cm) | 1.1E+07 |
| H/H | |
| T2 relaxation time (μsec) | 323 |
| Evaluation of bleed | C |
| Evaluation of image | |
| Evaluation of pinhole leak | A |
| Evaluation of horizontal streak | D |

It should be noted that, in Tables 7 and 8, values denoted by “4.3E+08” and the like represent “4.3×10⁸” and the like.

When the electroconductive roller including the electroconductive resin layer containing the ion conducting agent according to the present invention described in each Example is compared to the electroconductive roller including the electroconductive resin layer containing the ion conducting agent according to Comparative Example, it is understood that each Example is excellent in continuous image output durability. This is considered to be ascribed to the fact that the ion conducting agent according to the present invention is advantageous in a decrease in resistance in the L/L environment and is less liable to contribute to an increase in resistance in the continuous output durability evaluation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-102898, filed May 16, 2014, which is hereby incorporated by reference herein in its entirety.

What is claimed is:

1. An electrophotographic member, comprising: an electroconductive substrate; and an electroconductive resin layer formed on the electroconductive substrate,
the electroconductive resin layer comprising a cation and at least one kind of a bis(oxalato)borate anion or a tris(oxalato)phosphate anion.

2. An electrophotographic member according to claim 1, wherein a spin-spin relaxation time T2 of the electroconductive resin layer with a hydrogen nucleus as a measurement nucleus, which is determined by pulse NMR measurement, is 1,000 microseconds (μsec) or less in an environment having a temperature of 15° C. and a relative humidity of 10% RH.

3. An electrophotographic member according to claim 1, wherein the electroconductive resin layer comprises a binder resin.

4. An electrophotographic member according to claim 3, wherein the binder resin has a siloxane structure represented by the following chemical formula (1): 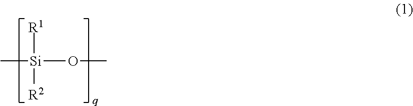
in the chemical formula (1), R¹ and R² each independently represent a methyl group or an unsubstituted phenyl group, and q represents an integer of 1 or more.

5. An electrophotographic member according to claim 1, wherein the cation comprises a quaternary ammonium cation.

6. An electrophotographic member according to claim 1, wherein the cation comprises a resin having a cationic group chemically bound thereto.

7. An electrophotographic member according to claim 6, wherein the resin comprises a urethane resin.

8. A process cartridge, which is removably mounted onto a main body of an electrophotographic apparatus, the process cartridge comprising at least one of a charging unit or a developer carrier,
wherein at least one of the charging unit or the developer carrier comprises the electrophotographic member of claim 1.

9. An electrophotographic apparatus, comprising: an electrophotographic photosensitive member; and at least one of a charging unit or a developer carrier,
wherein at least one of the charging unit or the developer carrier comprises the electrophotographic member of claim 1.
